(19) United States
(12) Patent Application Publication
(10) Pub. No.: US 2009/0026776 A1
(43) Pub. Date: Jan. 29, 2009

(54) Removable vehicle side guards

(76) Inventor: Josephine Gamble Simmons, West Palm Beach, FL (US)

Correspondence Address: Josephine Simmons, 124 Lake Constance Drive, West Palm Beach, FL, 33411, US

(21) Appl. No.: 11/881,052

(22) Filed: Jul. 25, 2007

(51) Int. Cl. B60R 19/42

(52) U.S. Cl. 293/128

(57) ABSTRACT

A removable vehicle door guard for use on a vehicle includes a pair of elongated door guards and a secure locking device. The pair of elongated door guards are interconnected by a linkage. The pair of elongated door guards each include magnets that are utilized to secure the pair of elongated door guards to a vehicle door and other external surfaces of the vehicle. The secure locking device is also interconnected to the linkage. The secure locking device includes a magnet that enables the secure locking device to be positively positioned to a door jam, and when the car door is closed, the secure locking device is captured between the vehicle door and the door jam.

### BACKGROUND

Removable vehicle side guards have been available in a variety of designs for many years. Most removable vehicle side guards were designed to resemble the decorative trim placed on the door and fender panels of a new vehicle or as customizable trim for new and existing vehicles. Most of these removable vehicle side guards were generally bulky, often rigid, often difficult to install, and store, and often intended to be left where positioned on the vehicle. Various methods have been proposed to secure the removable vehicle side guards while they are placed on the vehicle, however most of the methods of securing the removable vehicle side guards do not function correctly for all types of vehicles, such as sedans, coupes, two and four door vehicles, SUVs and pickup trucks.

What is needed is a removable vehicle side guard that is lightweight and can be easily attached to a vehicle when the vehicle is to be parked, and easily removable when the vehicle is to be driven. What is also needed is a removable vehicle side guard that can easily be stored within the vehicle, or within the trunk of a vehicle. What is further needed is a removable vehicle side guard that provides for securing the side guard to a vehicle when in place. What is further needed is that the securing device be able to be positively positioned in a location to accommodate any type of vehicle with which the removable vehicle side guard is used.

### BRIEF DESCRIPTION OF THE DRAWINGS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description, like reference numerals are used to describe the same, similar or corresponding parts in the several views of the drawings.

FIG. 1 is an elevational view of a removable vehicle side guard in accordance with the present invention.

FIG. 2 is a rear elevational view of a foam plank illustrating a number of aspects of assembly.

FIG. 3 is a front elevational view of the foam plank illustrating additional aspects of assembly.

FIG. 4 is a sectional view of the foam plank further illustrating several of the aspects of assembly.

FIG. 5 is an elevational view of the assembly of a securing device in accordance with the present invention.

FIG. 6 is a perspective view illustrating the placement of the securing device.

FIG. 7 is an illustration of an automobile having the removable vehicle side guard placed on the vehicle.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

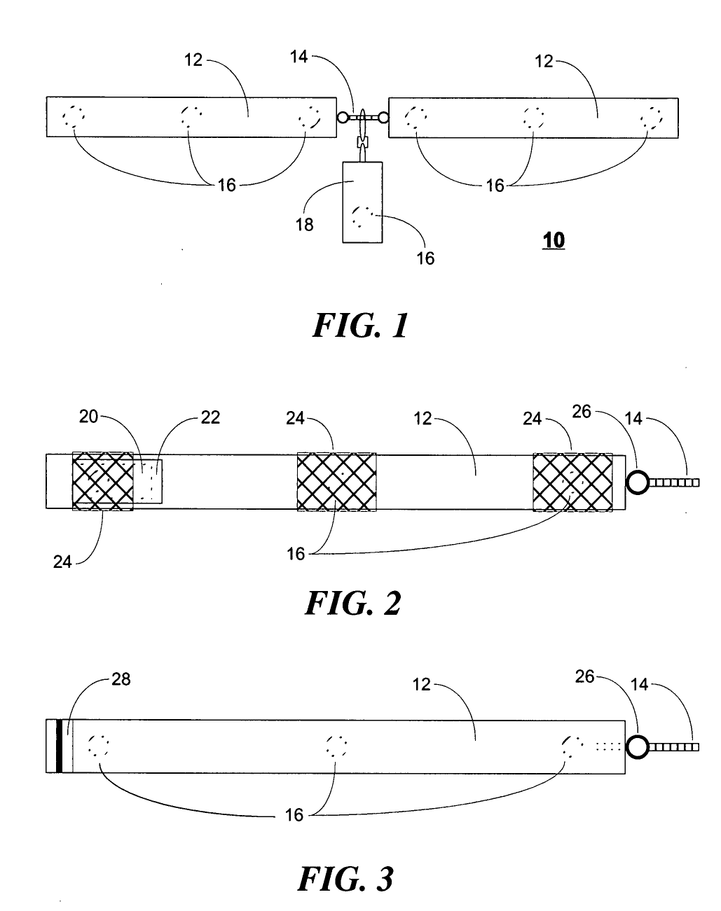

Referring to FIG. 1 is shown an elevational view of a removable vehicle side guard 10 in accordance with the present invention. The removable vehicle side guard 10 includes two elongated door guards 12 formed from foam planks interconnected using a linkage 14 such as a spring 14 as will be described in further detail below. The elongated door guards 12 will herein after be referred to as foam planks 12, and the linkage 14 will herein after be referred to as spring 14 in the description provided below. Positioned within the foam planks 12 are a number of magnets 16, three of which are shown by way of example. A securing device 18 is connected to the spring 14 in a manner to be described in detail below. The securing device 18 includes a magnet 16 which enables the securing device to positively be positioned on a door jam was will be described in further detail below.

By way of example the foam planks 12 are fabricated using a PolyLam® foam plank material such as manufactured by Pactiv Corporation, 1900 W. Field Court, Lake Forest, Ill. 60045. The foam planks 12 are by way of example 1″ (2.54 cm)×3″ (7.62 cm)×48″ (121.92 cm) in size, for a total overall length of the removable vehicle side guard 10 to be somewhat in excess of 96″ (243.84 cm) as will be described further below. It will be appreciated that the length of the foam planks 12 and resultant overall length of the removable vehicle side guard 10 can be adjusted to accommodate different size vehicles. Likewise, the height and thickness of the foam planks 12 can be adjusted to be greater or smaller to also accommodate different size vehicles or the styling of the sides of the vehicles. Other materials can be used for the fabrication of the foam planks 12, such as multi-density PolyLam® foam planks and other polymer foam products.

It will be appreciated by one of ordinary skill in the art that various magnet materials and geometries can be utilized for the magnets 16. By way of example, the magnets 16 positioned at the ends of the foam planks 12 are rectangular ceramic bar magnets, model CB29 having dimensions of ¾″ (1.90 cm)×2.5″ (6.36 cm)×0.214″ (0.54 cm) and are positioned so that their major axis extends the length of the foam planks 12. The magnet 16 positioned at the center of the foam plank 12 is also a rectangular ceramic bar magnet model CB247 having dimensions of ¾″ (1.90 cm)×2″ (5.08 cm)×0.25″ (0.635 cm) and is positioned so that the major axis is perpendicular to the length of the foam planks 12. It will be appreciated that other magnet geometries, such as ring magnets; and magnetic materials, such as alnico, samarium-cobalt, and neodymium magnets can be utilized as well. It will be further appreciated the ultimate size of the magnet depends upon the magnetic material selected and the thickness of the intervening protective layers between the magnet and the vehicles finish.

Referring to FIG. 2 there is shown a rear elevational view of a foam plank illustrating a number of aspects of assembly. The magnets 16 are located on the rear surface of the foam planks 12 in a manner to be described further below. By way of example, a fiberglass joint tape 20, such as manufactured by Henkel Consumer Adhesives, 31250 Just Imagine Drive, Avon, Ohio 44011, is used to secure the magnets 16 in position. The fiberglass joint tape is preferably 1⅞″ (4.76 cm) wide, although it will be appreciated that other tape widths can be utilized as well depending upon the dimensions of the foam planks 12 utilized. By way of example, the fiberglass joint tape 20 extends approximately 3″ (7.62 cm) beyond the ends of the magnets 16. Positioned above the fiberglass joint tape 20 is a second tape, hereinafter referred to as UV tape 22, also fiberglass but having a more durable outer surface. In addition, the UV tape 22 preferably has a greater width than the fiberglass joint tape 20, and which by way of example is 2.5″ (6.35 cm). The UV tape 22 insures the magnets 16 do not contact the vehicle's finish causing any form of scraping or abrasion as the removable vehicle side guards 10 are repeatedly positioned and removed. The second UV tape 22 also extends approximately 3″ (7.62 cm) beyond the ends of the magnets 16. Wrapping the foam planks 12 and covering the UV tape 22 is a protective mesh 24. The protective mesh 24 is by way of example a Vexar® Superrduty Elastic Sleeve number NG5015 manufactured by Internet, 1201 Lund Boulevard, Anoka, Minn. 55303. As shown in FIG. 2, the protective mesh 24 also extends approximately 3″ (7.62 cm) beyond the ends of the magnets 16. The protective mesh 24 can be cut to extend to any distance beyond the magnets 16 and can also be cut to cover the entire length of the foam planks 12. The protective mesh 24 adds further to preventing abrasion of the surface of the vehicle when the removable protective device 10 is placed or removed. In addition, the protective mesh 24 can be obtained in a variety of colors, thereby matching to some extent the finish of the vehicle and enhancing the visual appeal of the removable vehicle side guard 10 in accordance with the present invention when in position when placed on the vehicle.

Referring to FIG. 3 there is shown a front elevational view of the foam plank 12 illustrating additional aspects of assembly of the foam plank 12 with the protective mesh 24 removed. By way of example, an eyebolt 26 is utilized to connect one foam plank to the other foam plank using a spring 14. The eyebolt 26 is zinc plated and has a 3/16″ machine thread that is 2½″ long, such as manufactured by Coron Bolt Company, Alisa Viejo, Calif. 92656. By way of example, a pilot hole is formed in one end of a foam plank 12 using a drill bit, awl, ice pick or other penetrating device. The threaded portion of the eyebolt 26 is preferably coated with a multi-purpose adhesive such as manufactured by OCI USA, Inc., 8560 NW 64^{th} St., Miami, Fla., and placed within the pilot hole wherein the adhesive secures the eyebolt 26 to the foam plank 12. By way of example an extension spring having an 11/32″ (0.9 cm) O. D., a 1⅞″ (4.8 cm) length and a 0.025″ (0.06 cm) wire diameter, such as manufactured by Prime Line Products Company, San Bernadino, Calif. 92407 is used to connect one eyebolt 26 attached to one foam plank 12 the other eyebolt 26 attached to the other foam plank 12.

Also by way of example, opposite the end of the foam plank 12 that the eyebolt 26 is attached, a decorative tape 28 can also be secured. When a decorative tape is utilized it is preferably wrapped around the foam plank 12.

It will be appreciated that other methods of securing one foam plank to the other can be utilized and other methods of providing the decorative strip can be utilized. As an example, molded plastic caps can be provided that fit over the ends of the foam plank 12. One plastic cap can be molded to enable securing one foam plank to another foam plank such as by using the spring described above, while a second plastic cap can be molded that is printed with any number of decorative designs. A manufacturers name and part number can also be molded into one or both end caps to identify the source of the product.

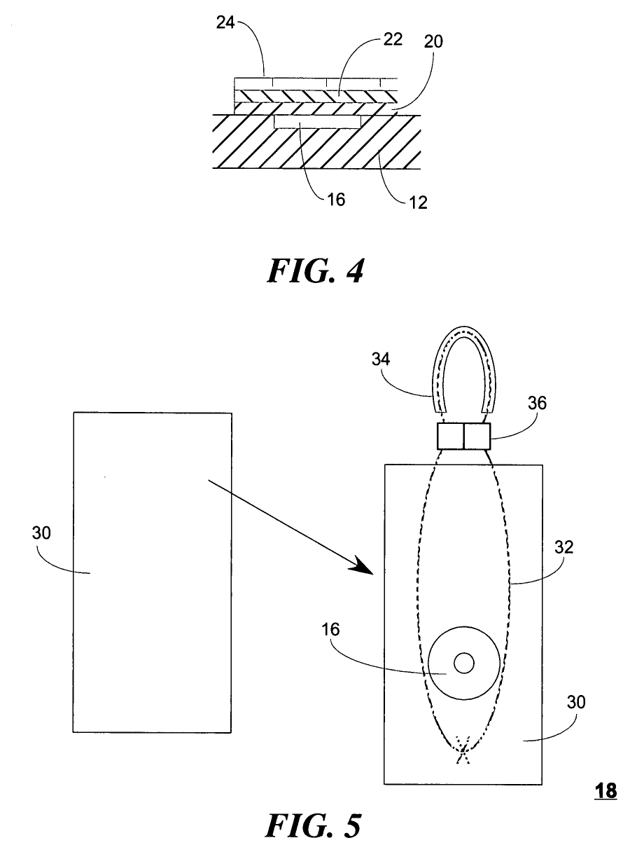

Referring to FIG. 4 there is shown a sectional view of the foam plank 12 further illustrating several of the aspects of assembly. A magnet 16 is preferably mounted to the foam plank 12 within a recess or cavity formed within the foam plank 12. In accordance with the present invention, the fiberglass joint tape 20 is used to secure the magnet within the recess provided in the foam plank 12 as was described above. It will also be appreciated that other methods of securing the magnet 16 within the recess can be utilized, such as by the use of a construction adhesive applied within the cavity before the magnet 16 is set into position. In either instance, the UV tape 22 and the protective mesh 24 are utilized to insure the magnet 16 does not come in contact with the finish of the vehicle.

Referring to FIG. 5 there is shown an elevational view of the assembly of the secure locking device 18 in accordance with the present invention. The secure locking device 18 utilizes a magnet 16 that enables the secure locking device 18 to be positively positioned between the door and door frame on the door jam as will be described further below. The magnet 16 is by way of example a CR 145 ceramic ring magnet having an outer diameter of 1.25″ (3.175 cm) and an inner diameter of 0.375″ (0.95 cm) in accordance with the present invention. A small round neodymium magnet, ND060N that is ⅜″ (0.95 cm) in diameter by 0.1″ (0.25 cm) high (not shown) is placed within the circular opening of the ring magnet to improve the holding capacity of the magnet to position the secure locking device 18 to the doorjam.

The combined magnet assembly is positioned on the adhesive surface of a tape 30 having a tough, resilient shell and strong reinforced backing, such as Gorilla Tape®. The tape strip utilized is by way of example 1⅞″ (4.76 cm) wide by 6″ (15.24 cm) long. Further by way of example, a length of 1/16″ (0.159 cm) diameter wire rope 32 is used to secure the securing device 18 to the spring 14. A length of vinyl tubing 34, having by way of example a ¼″ (0.635 cm) O. D. and a 0.170″ (0.43 cm) I. D. is positioned at the center of the wire rope 32. An aluminum sleeve having two holes to accept 3/32 (0.238 cm) diameter wire rope is positioned such as to abut the vinyl sleeve 34 and is crimped into position leaving a loop having approximately a 2″ diameter by which the secure locking device 18 is attached to the spring 14. The free ends of the wire rope are twisted together to form a second larger loop that is positioned on the tape 30 about the magnet 16 as shown. A second tape 30 is affixed to the first tape 30, adhesive side to adhesive side, to form a tough outer shell that encloses and captures the magnet 16 and wire rope 32.

It will be appreciated that other assembly methods can be utilized to form the secure locking device 18 other than that described above. A die-cut foam core can be utilized to locate the magnet, and the tough outer shell can be formed simply by affixing a strip of tape 30 to each side of the die-cut foam core. Likewise a durable vinyl or other flexible polymer shell can be formed about the assembled die-cut foam core that is seal along the edges such as by of a heat-sealing process or a thermal compression process to complete the assembly. It will be appreciated that other forms of sealing can be utilized as well, such as with adhesives suitable to the material being sealed. Also the magnet 16 and wire rope 32 can be positioned within a mold and a resilient, flexible polymer, such as a silicon polymer can be molded over the parts to complete the shell of the secure locking device 18.

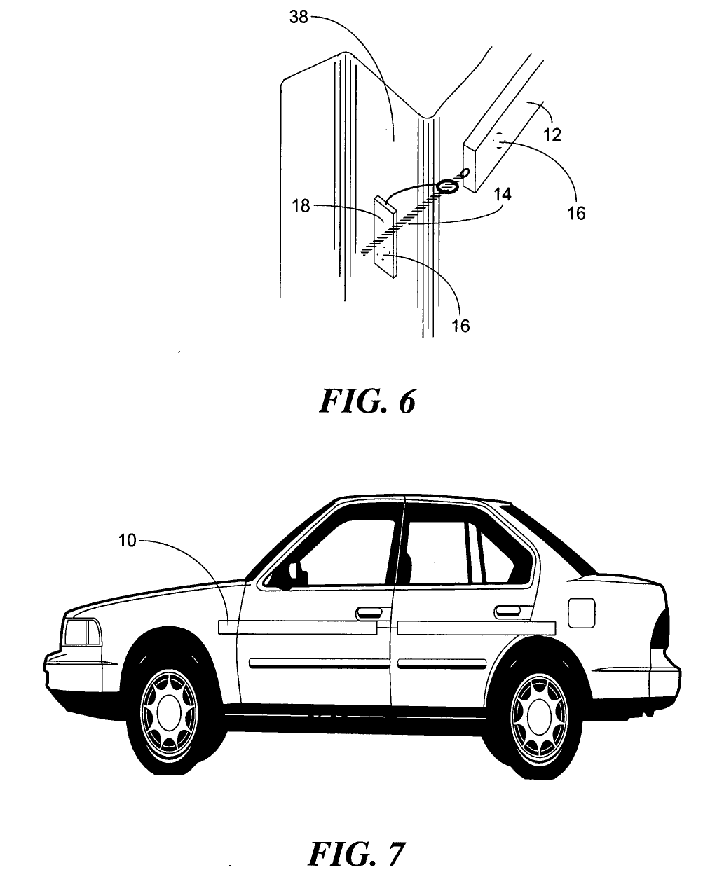

Referring to FIG. 6 is shown a perspective view illustrating the placement of the secure locking device 18. It will be appreciated that the size of the doorjam 38 to which the secure locking device 18 is positioned can vary widely from vehicle to vehicle according the manufacturer's make and model of the vehicle. As a result the secure locking device 18 in accordance with the present invention allows the user to positively position the secure locking device 18 at any position along the door jam 38 that will insure the secure locking device 18 is captured between the door and the door jam 38 when the door is closed. The magnet 16 positively positions the secure locking device 18 in the position at which the secure locking device 18 is placed by the user until the door is closed.

Referring to FIG. 7 is shown an illustration of an automobile having the removable vehicle side guard 10 in place on the vehicle. Placement of the removable 15 vehicle side guard 10 in accordance with the present invention is simple. The driver or passenger side door is first opened. Next the foam plank 12 is attached to the rear door and/or rear quarter panel of the vehicle. The secure locking device 18 is positioned at a suitable location on the door jam. The front or passenger side door is than closed and locked. The other foam plank 12 is attached to the driver or passenger side door and/or part of the front quarter panel of the vehicle.

Removing the removable vehicle door guard 10 in accordance with the present invention is just as simple. The foam plank 12 protecting the driver or passenger side doors is removed. The driver or passenger door is unlocked and opened. The secure locking device 18 is removed from the door jam and then the foam plank 12 covering the rear door and/or the rear quarter panel is removed.

The secure locking device 18 prevents the unauthorized removal of the removable vehicle door guard 10 by anyone other than the owner of the vehicle. The magnet provided within the secure locking device 18 advantageously is used to positively position the secure locking device 18 to the doorjam, thereby ensuring that the secure locking device 18 is properly captured between the door and the door jam when the door is closed and locked.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

1. A removable vehicle door guard for use on a vehicle, comprising:
a pair of elongated door guards interconnected by a linkage, wherein said pair of elongated door guards each include a plurality of magnets that are utilized to secure said pair of elongated door guards to a vehicle door and other external surfaces of the vehicle; and
a secure locking device, also interconnected to said linkage, wherein said secure locking device includes a magnet that enables said secure locking device to be positively positioned to a door jam, and wherein when said vehicle door is closed, said secure locking device is captured between said vehicle door and said door jam.

2. The removable vehicle door guard according to claim 1 wherein said secure locking device further comprises a wire forming a wire loop that is used to interconnect said secure locking device to said linkage.

3. The removable vehicle door guard according to claim 1 further comprising a decorative strip positioned at ends of said pair of elongated door guards opposite said linkage.

4. The removable vehicle door guard according to claim 1 wherein said plurality of magnets are selected from a group of magnets consisting of ceramic, alnico, samarium cobalt and neodymium magnetic materials.

5. The removable vehicle door guard according to claim 1, wherein said elongated door guards each comprise a foam plank into which said plurality of magnets are affixed.

6. The removable vehicle door guard according to claim 5, wherein said foam plank has a rectangular cross section.

7. The removable vehicle door guard according to claim 5 further comprising one or more layers of tape used to affix said magnets within said foam plank.

8. The removable vehicle door guard according to claim 7 further comprising protective mesh used to encase at least portions of said foam plank about said plurality of magnets.

9. The removable vehicle door guard according to claim 2 wherein said secure locking device further comprises a flexible shell that encases said magnet and said at least a portion of said wire.

10. The removable vehicle door guard according to claim 9 wherein said flexible shell comprises two strips of tape.

11. The removable vehicle door guard according to claim 9 wherein said flexible shell is molded from a flexible polymer.

12. The removable vehicle door guard according to claim 11 wherein said flexible polymer is a silicon rubber polymer.

13. The removable vehicle door guard according to claim 9 wherein said flexible shell comprises two flexible polymer sheets having edges extending to enclose said magnet and said wire, and wherein said edges are bonded to secure said magnet and said wire.

14. The removable vehicle door guard according to claim 13 wherein said edges are thermally bonded.
